(19) United States
(12) Patent Application Publication
(10) Pub. No.: US 2002/0197079 A1
(43) Pub. Date: Dec. 26, 2002

(54) Non-water-based resist stripping liquid management apparatus and non-water-based resist stripping liquid management method

(76) Inventors: Toshimoto Nakagawa, Kawasaki-shi (JP); Yuko Katagiri, Kawasaki-shi (JP); Sho Ogawa, Tokyo (JP); Satoru Morita, Tokyo (JP); Makoto Kikukawa, Yokohama-shi (JP)

Correspondence Address: ROSENTHAL & OSHA L.L.P., 1221 MCKINNEY AVENUE, SUITE 2800, HOUSTON, TX, 77010, US

(21) Appl. No.: 10/177,220

(22) Filed: Jun. 21, 2002

(30) Foreign Application Priority Data
Jun. 25, 2001 (JP) P2001-191697

(51) Int. Cl. G03D 3/00

(52) U.S. Cl. 396/564

(57) ABSTRACT

The non-water-based resist stripping liquid management apparatus according to the present invention manages in an adjusting bath a non-water-based resist stripping liquid that is used in resist stripping equipment. In this apparatus, an absorptiometer that measures the MEA concentration in the non-water-based resist stripping liquid and an analyzer that measures the degraded component concentration in the non-water-based resist stripping liquid are connected to a resist stripping treatment bath (adjusting bath) via pipelines, and at least one of a resist stripping stock liquid, an MEA stock liquid, a resist stripping reclaimed liquid, and a premixed resist stripping new liquid are fed into the resist stripping treatment bath in accordance with the measurement values obtained. As a result, the resist stripping performance of the non-water-based resist stripping liquid can be stably maintained, the amount of liquid used can be reduced, and the time for which operation is shut down can be reduced.

### BACKGROUND OF THE INVENTION

1. Field of the Invention

The present invention relates to a management apparatus and management method for anon-water-based resist stripping liquid used in the stripping of resists in a semiconductor manufacturing process or the like.

2. Description of the Related Art

A resist material used in a photolithography step in a semiconductor manufacturing process or a flat panel display substrate manufacturing process may be a positive type that becomes soluble upon exposure to light or a negative type that becomes insoluble upon exposure to light, although it is the positive type that is used predominantly. A typical example of a positive type resist has as principle components thereof a naphthoquinone diazido type photosensitizer and an alkali-soluble resin (novolac resin).

In the final stage of the photolithography step, it is necessary to completely strip the resist from the substrate. This resist stripping process for a semiconductor or a flat panel display substrate includes both a dry ashing step using an oxygen plasma and a wet stripping step using a resist stripping liquid. During the dry ashing step using the oxygen plasma, silicon oxide and/or aluminum oxide is produced on the substrate, and hence in the subsequent wet stripping step it is necessary not only to strip the resist but also to completely remove such metal oxides.

Regarding the above, Japanese Patent Application Laid-open No. 7-235487 discloses a resist stripping liquid management apparatus that comprises resist stripping liquid discharge means that detects the concentration of resist dissolved in a resist stripping liquid using an absorptiometer and discharges the resist stripping liquid, first replenishing means that detects the liquid surface level of the resist stripping liquid using a liquid surface level gauge and replenishes with organic solvent and alkanolamine, or replenishes with resist stripping new liquid in which the organic solvent and the alkanolamine have been premixed, and second replenishing means that detects the concentration of the alkanolamine in the resist stripping liquid and replenishes with at least one of the organic solvent and the alkanolamine.

Moreover, Japanese Patent Application Laid-open No. 10-22261 discloses a resist stripping liquid management apparatus that comprises resist stripping liquid discharge means that detects the concentration of resist dissolved in a resist stripping liquid using an absorptiometer and discharges the resist stripping liquid, first replenishing means that detects the liquid surface level of the resist stripping liquid using a liquid surface level gauge and replenishes with resist stripping stock liquid and pure water or replenishes with resist stripping new liquid in which the resist stripping stock liquid and pure water have been premixed, and second replenishing means that detects the water concentration in the resist stripping liquid using an absorptiometer and replenishes with at least one of the resist stripping stock liquid and pure water.

In the resist stripping process for a semiconductor or a flat panel display substrate, an organic solvent solution, an organic alkali solution, a mixed solution of an organic solvent and an organic alkali or the like is used as the resist stripping liquid. Examples include a solution of a dimethylsulfoxide, a solution of an N-methylpyrrolidone derivative, and a mixed solution of glycol ether and an alkanolamine. These resist stripping liquids are used with a spraying method, a dipping method or the like.

### SUMMARY OF THE INVENTION

With the prior art described above, however, a batch operation format is used in which a resist stripping treatment bath (adjusting bath) is filled with a certain amount of resist stripping new liquid of a prescribed concentration and operation is begun, and then using the number of substrates treated or the like as an indicator based on experience or the like, once the amount of the resist stripping liquid has dropped and a prescribed degraded concentration range has been reached, all of the resist stripping liquid is replaced with pre-prepared new liquid.

The frequency with which the replacement of the resist stripping liquid is carried out is not fixed, depending on the volume of the bath, the substrate type, the number of substrates treated and so on, but is usually about once every 4 days. If the resist stripping liquid degrades, then it will not be possible to obtain a constant stripping rate, and stripping residue and metal oxide residue will arise, resulting in the yield dropping. The financial loss is great if defective articles arise in this way in the resist stripping process, which is the final stage of the photolithography step.

Moreover, a non-water-based solution used as a resist stripping liquid is generally used at a temperature in a range of 70 to 90° C. The boiling points of the components used in the resist stripping liquid are about 190 to 240° C. for the organic solvent and about 160 to 190° C. for the alkanolamine (for example 171° C. for monoethanolamine (hereinafter referred to as ‘MEA’)) . The MEA, which has the lower boiling point, thus evaporates preferentially into the exhaust gas that is discharged in a large amount from the resist stripping treatment bath during use of the resist stripping liquid, and hence the MEA concentration in the resist stripping liquid drops, i.e. changes in this concentration occur.

Moreover, the alkali MEA is degraded by reaction with acid in the dissolved resist, reaction with carbon dioxide absorbed from the air to produce a degradation product, a decomposition reaction and so on. Furthermore, MEA tends to degrade by being oxidized by oxygen gas absorbed from the air to produce a degradation product (an oxamide). If the oxamide concentration becomes excessively high, then crystals of the oxamide will precipitate out, and hence the concentration of active MEA will progressively drop. Conventionally, however, the active MEA concentration has not been measured continuously in real time, and moreover control has not been carried out to make the active MEA concentration constant.

Furthermore, the concentration of resist that has dissolved in the resist stripping liquid through the resist stripping treatment progressively increases, and this is one cause of the degradation of the resist stripping performance. That is, as the dissolved resist concentration increases, the resist stripping rate drops, and also stripping residue is generated, and hence the resist stripping performance drops. In addition, a large amount of gas is exhausted from out of the resist stripping treatment apparatus, and hence a corresponding large amount of air is sucked in, which further promotes the degradation described above.

Degraded components in the resist stripping liquid thus include dissolved resist, products produced through the neutralization reaction of the alkali MEA with acid in the dissolved resist, degradation products produced through the MEA reacting with carbon dioxide absorbed from the air, degradation products produced through the MEA being oxidized by oxygen absorbed from the air, and other byproducts and the like. However, conventionally the concentration of these degraded components has not been measured continuously in real time, and moreover control has not been carried out to make the degraded component concentration constant.

With the prior art described above, the MEA concentration and the degraded component concentration are thus not constant but rather change with time, and hence metal oxide residue and stripping residue from the resist are generated, or a thin film residue of degraded components arises, and thus highly precise control of dimensions, which is considered to be necessary in the manufacture of flat panel display substrates and the like, has tended to be difficult. There has thus been a problem that the product quality becomes unstable, and the yield drops. Moreover, there has been the disadvantage that shutting down operation (‘down time’) during replacement of the resist stripping liquid leads to a drop in operation rate, and the work of replacing the resist stripping liquid results in an increase in labor costs.

In view of this state of affairs, it is an object of the present invention to provide a non-water-based resist stripping liquid management apparatus and method, according to which control is carried out such that the MEA concentration and the degraded component concentration in the non-water-based resist stripping liquid are constant, and suitable management of replenishment of liquid into an adjusting bath such as a resist stripping treatment bath is carried out, and hence the resist stripping performance can be made constant, and moreover the amount used of the non-water-based resist stripping liquid can be reduced, and the time for which operation is shut down can be reduced, and hence overall costs can be reduced.

The present inventors carried out assiduous studies to attain the above object, and as a result discovered that a non-water-based resist stripping liquid degrades by reacting for example with oxygen, carbon dioxide or the like in the air to produce various acids, salts and oxides (oxidation products) thereof and the like, thus accomplishing the present invention. Specifically, the non-water-based resist stripping liquid management apparatus according to the present invention, which is an apparatus that manages in an adjusting bath a non-water-based resist stripping liquid that is used in resist stripping equipment, comprises degraded component concentration measurement means for measuring the concentration of a degraded component originating from the non-water-based resist stripping liquid in the adjusting bath, liquid feeding means for feeding into the adjusting bath at least one of a non-water-based resist stripping stock liquid, a non-water-based resist stripping reclaimed liquid, and a premixed non-water-based resist stripping new liquid, and liquid feeding amount control means for controlling the amount of liquid fed into the adjusting bath in accordance with the measured degraded component concentration.

According to the non-water-based resist stripping liquid management apparatus having such a constitution, the concentration of a degraded component originating from the non-water-based resist stripping liquid in the adjusting bath is measured, and the amount of liquid fed into the adjusting bath is controlled in accordance with this measured degraded component concentration. As a result, the MEA concentration and the degraded component concentration in the non-water-based resist stripping liquid can be maintained at desired target values, and continuous operation for a prolonged time with a stable liquid surface level becomes possible.

Moreover, it is preferable for the degraded component concentration measurement means to measure the concentration of a chemical species or chemical component that has arisen or can arise potentially through reaction of a constituent component of the non-water-based resist stripping liquid in the adjusting bath and/or a decomposition product of such a constituent component with oxygen and/or carbon dioxide in a gas containing oxygen and/or carbon dioxide.

If such a constitution is adopted, then by measuring the degraded component concentration, it becomes possible to measure the extent of degradation of the non-water-based resist stripping liquid. According to the understanding of the present inventors, in the case for example that organic acids produced from constituent components or the like of the non-water-based resist stripping liquid, or oxides or salts thereof, and nitrogen-containing organic compounds (such as amines) are present, examples of the above-mentioned degraded component include products of condensation reactions between these acids or oxides and these nitrogen-containing organic compounds (such as amines).

Alternatively, it is also preferable for the degraded component concentration measurement means to comprise at least one of a viscosimeter that measures the viscosity of the non-water-based resist stripping liquid in the adjusting bath and an electrical conductivity meter that measures the electrical conductivity of the non-water-based resist stripping liquid in the adjusting bath.

In studies carried out by the present inventors, it was verified that the concentration of degraded components dissolved in the non-water-based resist stripping liquid in the resist stripping treatment bath is correlated to the viscosity and the electrical conductivity of the non-water-based resist stripping liquid (there is a highly linear relationship). By measuring the viscosity or the electrical conductivity of the non-water-based resist stripping liquid in the adjusting bath, it is thus possible to ascertain the degraded component concentration, and hence it becomes possible to measure the extent of degradation of the non-water-based resist stripping liquid.

Moreover, the non-water-based resist stripping liquid management method according to the present invention, which is a method of managing in an adjusting bath a non-water-based resist stripping liquid that is used in resist stripping equipment, and which can be implemented effectively using the non-water-based resist stripping liquid management apparatus of the present invention, comprises a degraded component concentration measurement step of measuring the concentration of a degraded component originating from the non-water-based resist stripping liquid in the adjusting bath, a liquid feeding step of feeding into the adjusting bath at least one of a non-water-based resist stripping stock liquid, a non-water-based resist stripping reclaimed liquid, and a premixed non-water-based resist stripping new liquid, and a liquid feeding amount control step of controlling the amount of liquid fed into the adjusting bath in accordance with the measured degraded component concentration.

According to such a non-water-based resist stripping liquid management method, the concentration of a degraded component originating from the non-water-based resist stripping liquid in the adjusting bath is measured, and the amount of liquid fed into the adjusting bath is controlled in accordance with the measured degraded component concentration. As a result, the MEA concentration and the degraded component concentration in the non-water-based resist stripping liquid can be maintained at desired target values, and continuous operation for a prolonged time with a stable liquid surface level becomes possible.

Moreover, in the degraded component concentration measurement step, it is preferable for the concentration to be measured of a chemical species or chemical component that has arisen or can arise potentially through reaction of a constituent component of the non-water-based resist stripping liquid in the adjusting bath and/or a decomposition product of such a constituent component with oxygen and/or carbon dioxide in a gas containing oxygen and/or carbon dioxide.

Alternatively, in the degraded component concentration measurement step, it is also preferable for at least one of the viscosity and the electrical conductivity of the non-water-based resist stripping liquid in the adjusting bath to be measured.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a diagram showing the constitution of a preferable embodiment of the non-water-based resist stripping liquid management apparatus according to the present invention;

FIG. 2 is a graph showing the relationship between the MEA concentration in a non-water-based resist stripping liquid and the absorbance;

FIG. 3 is a graph showing the relationship between the number of substrates subjected to resist stripping treatment and the degraded component concentration in the non-water-based resist stripping liquid;

FIG. 4 is a graph showing the relationship between the number of substrates subjected to resist stripping treatment and the viscosity of the non-water-based resist stripping liquid;

FIG. 5 is a graph showing the relationship between the degraded component concentration in the non-water-based resist stripping liquid and the viscosity of the non-water-based resist stripping liquid;

FIG. 6 is a graph showing the relationship between the number of substrates subjected to resist stripping treatment and the electrical conductivity of the non-water-based resist stripping liquid;

FIG. 7 is a graph showing the relationship between the degraded component concentration in the non-water-based resist stripping liquid and the electrical conductivity of the non-water-based resist stripping liquid;

FIG. 8 is a graph showing the relationship between the MEA concentration in the non-water-based resist stripping liquid and the operating time in the case of a conventional non-water-based resist stripping liquid management method;

FIG. 9 is a graph showing the relationship between the MEA concentration in the non-water-based resist stripping liquid and the operating time in the case of using the non-water-based resist stripping liquid management apparatus and method according to the present invention;

FIG. 10 is a graph showing the relationship between the degraded component concentration in the non-water-based resist stripping liquid and the operating time in the case of a conventional non-water-based resist stripping liquid management method; and

FIG. 11 is a graph showing the relationship between the degraded component concentration in the non-water-based resist stripping liquid and the operating time in the case of using the non-water-based resist stripping liquid management apparatus and method according to the present invention.

### DESCRIPTION OF THE PREFERRED EMBODIMENTS

Before an embodiment of the present invention is described, an outline description will be given of matters relating to degraded components in the non-water-based resist stripping liquid and management of the concentration thereof.

As described above, the present inventors discovered that a non-water-based resist stripping liquid degrades by reacting for example with oxygen, carbon dioxide or the like in the air to produce various acids, salts and oxides thereof and the like. In the present invention, degraded components in the non-water-based resist stripping liquid refers to chemical species or chemical components that have arisen through reaction of constituent components of the non-water-based resist stripping liquid in the adjusting bath and/or decomposition products of such constituent components with oxygen and/or carbon dioxide in a gas containing oxygen and/or carbon dioxide, or chemical species or chemical components that can arise potentially through such a reaction.

In the case for example that organic acids produced from the constituent components or the like of the non-water-based resist stripping liquid, or oxides or salts thereof, and nitrogen-containing organic compounds (such as amines) are present, examples of such degraded components include products of condensation reactions between these acids or oxides and these nitrogen-containing organic compounds (such as amines).

More specifically, examples are compounds having in the molecule thereof an aldehyde group, a carboxyl group, an amino group, an amide group or the like, and yet more specifically, examples include oxamides such as N,N-bis (2-hydroxyethyl)oxamide, which is the final product of reaction.

The present inventors have found that such an oxamide dissolves in water but tends to precipitate out in IPA (isopropyl alcohol), and moreover even if dissolved in the stripping liquid at high temperature, precipitates out upon cooling. Moreover, the present inventors have found that if an oxamide is produced, then butyl diglycol (hereinafter referred to as ‘BDG’) and MEA are consumed. Furthermore, it has also been found that oxamides can cause piping to become clogged up.

Following is a description of the mechanism by which an oxamide is produced.

Firstly, BDG, which is represented by undermentioned formula (1), is hydrolyzed upon being heated with water, producing ethylene glycol and ethylene glycol monobutyl ether, which are represented by undermentioned formulae (2a) and (2b) respectively.

HO—(CH₂CH₂O)₂—C₄H₉ (1)

HO—CH₂CH₂—OH (2a)

HO—CH₂CH₂—O—C₄H₉ (2b)

Ethylene glycol and butyl alcohol are then produced from the ethylene glycol monobutyl ether by the hydrolysis reaction represented by undermentioned formula (3).

HO—CH₂CH₂—O—C₄H₉+H₂0→HO—CH₂CH₂—OH+HO—C₄H₉ (3)

The ethylene glycol is oxidized to produce glycol aldehyde, which is represented by undermentioned formula (4).

HO—CH₂—CHO (4)

The glycol aldehyde is further oxidized, being decomposed into glyoxal and glycolic acid, which are represented by undermentioned formulae (5) and (6) respectively.

OHC—CHO (5)

HO—CH₂—COOH (6)

Oxalic acid, which is represented by undermentioned formula (8), is then produced via glyoxylic acid, which is represented by undermentioned formula (7).

OHC—COOH (7)

HOOC—COOH (8)

The oxalic acid then reacts with MEA, which is represented by undermentioned formula (9), whereupon water is eliminated and N,N-bis (2-hydroxyethyl) oxamide, which is represented by undermentioned formula (10), is produced.

NH₂CH₂CH₂OH (9)

HO—CH₂CH₂—NH—CO—CO—NH—CH₂CH₂—OH (10)

Moreover, as described later, the present inventors found experimentally that the concentration of degraded components dissolved in the non-water-based resist stripping liquid in the resist stripping treatment bath is correlated to the viscosity and the electrical conductivity of the non-water-based resist stripping liquid (there are highly linear relationships) (see FIGS. 5 and 7). In the present invention, it is thus effective to obtain the degraded component concentration by measuring the viscosity or the electrical conductivity of the non-water-based resist stripping liquid and carry out adjustment/control accordingly.

Furthermore, the present inventors also found experimentally that there is a correlation (a highly linear relationship) between the MEA concentration in the non-water-based resist stripping liquid and the absorbance of the non-water-based resist stripping liquid. In the present invention, it is thus effective to obtain the MEA concentration by measuring the absorbance of the non-water-based resist stripping liquid and carry out adjustment/control accordingly.

As the resist stripping stock liquid in the present invention, for example a dimethylsulfoxide type stock liquid, an N-methylpyrrolidone type stock liquid, a diglycol type stock liquid, a mixed stock liquid of an alkanolamine and a glycol ether type solvent, one of these stock liquids with any of various additives added thereto, or the like can be used.

Examples of the alkanolamine include monoethanolamine, diethanolamine, triethanolamine, N,N-dimethylethanolamine, N,N-diethylethanolamine, aminoethylethanolamine, N-methyl-N,N-diethanolamine, N,N-dibutylethanolamine, N-methylethanolamine, and 3-amino-1-propanol.

Furthermore, examples of the glycol ether type solvent include butyl diglycol, diethylene glycol monomethyl ether, diethylene glycol monoethyl ether, and diethylene glycol monopropyl ether.

Moreover, additives include catechol, reducing agents, metal corrosion inhibitors, and chelating agents.

Following is a detailed description of an embodiment of the present invention. Note that equivalent elements are given the same reference numeral, and redundant repeated description is omitted. Moreover, positional relationships such as above, below, left and right follow the positional relationships shown in the drawings unless otherwise stated. Furthermore, the ratios of dimensions are not limited to being those shown in the drawings.

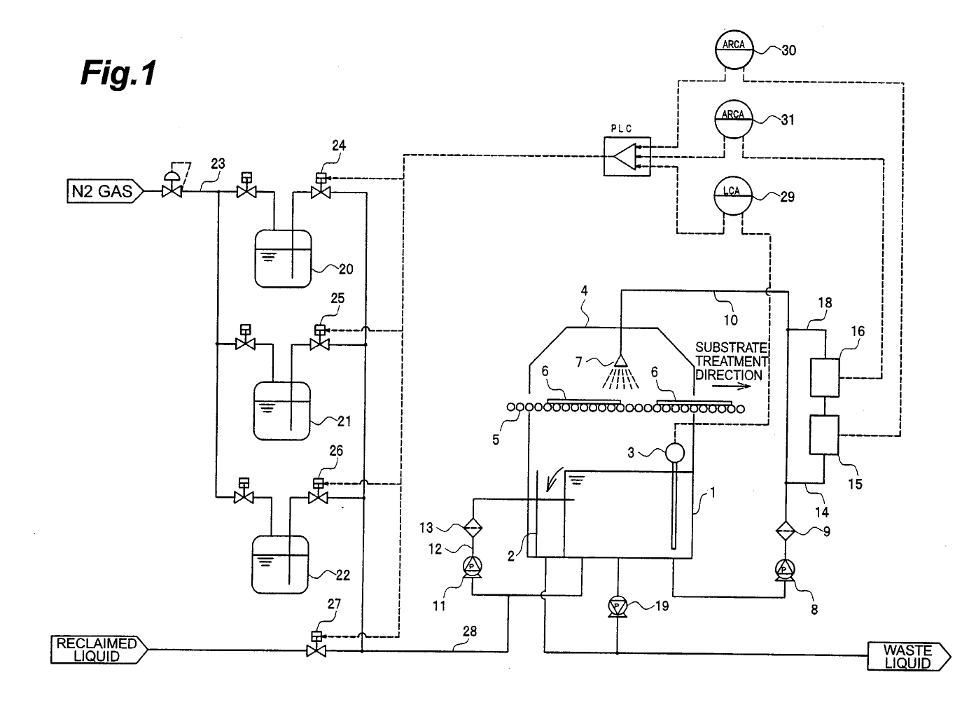

FIG. 1 is a diagram showing the constitution of a preferable embodiment of the non-water-based resist stripping liquid management apparatus according to the present invention. The non-water-based resist stripping liquid management apparatus of the present embodiment has a resist stripping treatment bath 1 (adjusting bath) which is installed below a roller conveyor 5 on which substrates 6 such as semiconductor wafers are placed and conveyed, and in which a non-water-based resist stripping liquid is stored, and a resist stripping liquid sprayer 7 that is disposed within a resist stripping chamber hood 4 above the roller conveyor 5 and is connected to the resist stripping treatment bath 1 via a pipeline 10.

The resist stripping treatment bath 1 is connected to a pipeline 12 in which are provided a circulating pump 11 and a filter 13 for removing fine particles, and the non-water-based resist stripping liquid is made to circulate as a result. Moreover, a pipeline 28 is connected to the pipeline 12, and a resist stripping stock liquid supply vessel 20, an MEA stock liquid supply vessel 21 (where the MEA stock liquid may be MEA only, or may be a solution that has MEA as a principal component thereof but also has an organic solvent mixed therein), a resist stripping new liquid supply vessel 22 and a resist stripping reclaimed liquid supply system are connected to the pipeline 28 via pipelines in which are provided flow rate control valves 24 to 27 respectively. The resist stripping stock liquid supply vessel 20, the MEA stock liquid supply vessel 21, the resist stripping new liquid supply vessel 22, the resist stripping reclaimed liquid supply system, the flow rate control valves 24 to 27, and the pipeline 28 together constitute the liquid feeding means.

An N₂ gas supply system is connected to the resist stripping stock liquid supply vessel 20, the MEA stock liquid supply vessel 21 and the resist stripping new liquid supply vessel 22 via piping 23. The resist stripping stock liquid supply vessel 20, the MEA stock liquid supply vessel 21 and the resist stripping new liquid supply vessel 22 are each pressurized to about 1 to 2 kgf/cm² with N₂ gas from the piping 23. By opening the flow rate control valve 24 for the resist stripping stock liquid, the flow rate control valve 25 for the MEA stock liquid, and the flow rate control valve 26 for the resist stripping new liquid by prescribed opening amounts, the resist stripping stock liquid (for example BDG (butyl diglycol), boiling point 230.6° C.), the MEA stock liquid and the resist stripping new liquid are fed under pressure into the resist stripping treatment bath 1.

Furthermore, the resist stripping reclaimed liquid is used non-water-based resist stripping liquid that has been reclaimed using for example a distillation reclamation method, or a membrane separation reclamation method using an NF membrane or the like; by opening the flow rate control valve 27 for the resist stripping reclaimed liquid by a prescribed opening amount, the resist stripping reclaimed liquid is fed into the resist stripping treatment bath 1 via the pipeline 28. The feeding amounts of the above replenishing liquids are adjusted using the respective flow rate control valves 24 to 27. The replenishing liquids flow together at the pipeline 28 and flow into the pipeline 12, and are then mixed with the circulating flow of the non-water-based resist stripping liquid, before being fed into the resist stripping treatment bath 1. Note that it is also possible to make each of the replenishing liquids flow directly into the pipeline 12 or the resist stripping treatment bath 1, without making the replenishing liquids flow together first.

Moreover, regarding the liquids replenished into the resist stripping treatment bath 1, it is not necessarily the case that all of the resist stripping stock liquid, the MEA stock liquid, the resist stripping new liquid and the resist stripping reclaimed liquid are required; rather, depending on the composition of the non-water-based resist stripping liquid, the extent of concentration changes, equipment conditions, operating conditions, availability of the replenishing liquids and so on, one may select one or more of the above replenishing liquids as the most suitable replenishing liquid(s) . Furthermore, the amount of liquid stored in the resist stripping treatment bath 1 only needs to be such that the required amount can be fed to the resist stripping liquid sprayer 7, but it is preferable to control the amount of liquid fed into the resist stripping treatment bath 1 from the viewpoint of implementing the process stably.

Moreover, a liquid surface level gauge 3, which is connected to a liquid surface level controller 29, is installed in the resist stripping treatment bath 1. During the resist stripping treatment of the substrates 6, there is a tendency for the non-water-based resist stripping liquid to stick to the substrates 6 and thus be taken outside the system, resulting in the amount of liquid in the resist stripping treatment bath 1 dropping. Dropping of the liquid surface level in the resist stripping treatment bath 1 due to this, or dropping of the liquid surface level when non-water-based resist stripping liquid for which the resist stripping performance has degraded is forcibly discharged to the outside of the resist stripping treatment bath 1, is thus detected by the liquid surface level gauge 3, and the amount of liquid in the resist stripping treatment bath 1 is controlled so as to be within a fixed range based on the detected value.

Furthermore, an overflow bath 2 is provided next to the resist stripping treatment bath 1, and drainage piping, which has therein a liquid discharge pump 19 and is connected to a waste liquid system, is connected to the resist stripping treatment bath 1 and the overflow bath 2. By operating the liquid discharge pump 19, non-water-based resist stripping liquid for which the resist stripping performance has degraded (i.e. degraded liquid) is made to flow down into the drainage piping. Note that it is also possible to make the constitution such that degraded liquid is discharged out of the system directly without passing through drainage piping.

Moreover, a liquid feeding pump 8 that pumps the non-water-based resist stripping liquid from the resist stripping treatment bath 1 to the resist stripping liquid sprayer 7, and a filter 9 for removing fine particles and the like from the resist stripping liquid, are provided in this order in the pipeline 10. Furthermore, downstream of the filter 9, a pipeline 14 splits off from the pipeline 10; an absorptiometer 15 and an analyzer 16 (degraded component concentration measurement means), which are connected to an absorbance controller 30 and an analyzer controller 31 respectively, are provided in the pipeline 14; connected downstream of the absorptiometer 15 and the analyzer 16 is a pipeline 18, which connects back to the pipeline 10. Furthermore, the liquid surface level controller 29, the absorbance controller 30 and the analyzer controller 31 are connected to the flow rate control valves 24 to 27 via an input/output apparatus.

The absorptiometer 15 and the analyzer 16 installed online in this way measure the absorbance and the viscosity respectively of the non-water-based resist stripping liquid in the resist stripping treatment bath 1. A sample liquid from the non-water-based resist stripping liquid is led into the absorptiometer 15 and the analyzer 16 from the pipeline 14, the absorbance and the viscosity are measured continuously, and the liquid on which the measurements have been carried out is returned back into the pipeline 10 via the pipeline 18. Note that the absorptiometer 15 and the analyzer 16 maybe installed separately between the pipeline 14 and the pipeline 18 as in FIG. 1, or may be integrated with one another.

Moreover, instead of using the circular path formed from the pipelines 14 and 18, the absorptiometer 15 and the analyzer 16 maybe installed at separated paths, or the sample liquid maybe led into the absorptiometer 15 and the analyzer 16 using a circulating pump for measurement. Furthermore, it is possible to install the absorptiometer 15 and the analyzer 16 directly in the resist stripping treatment bath 1, in which case the absorptiometer 15 and the analyzer 16 should each be of a probe type.

The absorptiometer 15, the analyzer 16, the liquid surface level gauge 3 and so on constitute the control system in the present embodiment. Moreover, the measurement and control of the liquid surface level in the resist stripping treatment bath 1 using the liquid surface level gauge 3, the measurement and control of the MEA concentration in the non-water-based resist stripping liquid using the absorptiometer 15, and the measurement and control of the degraded component concentration in the non-water-based resist stripping liquid using the analyzer 16 essentially function independently of one another, but in the present invention there is the characteristic feature that these are made to function with a mutually complementary relationship therebetween. Furthermore, the target value (management value) of the MEA concentration in the resist stripping liquid, and the degradation limit value (management value) of the degraded component concentration in the resist stripping liquid, that are necessary in terms of quality control of the product substrates are set into the various control instruments in advance based on past operating results or on the results of calculations (for example operation simulations).

Following is a description of the non-water-based resist stripping liquid management method of the present invention using the non-water-based resist stripping liquid management apparatus constituted as described above, taking the case of using a mixed solution of MEA and BDG as the non-water-based resist stripping liquid as an example.

Normally, the non-water-based resist stripping liquid is used kept at a constant temperature of about 80° C.. In this case, MEA, which has a low boiling point, evaporates preferentially from the non-water-based resist stripping liquid and is predominantly discharged with the large amount of exhaust gas. As a result, in the conventional method, the MEA concentration in the non-water-based resist stripping liquid drops as the number of substrates treated increases, and hence there is a gradual degradation of the resist stripping performance. It is thus necessary to manage the MEA concentration to be close to a prescribed target value, for example 39.0±1.0%. Conventionally, the extent of degradation of the non-water-based resist stripping liquid is judged based on a correlation between the extent of degradation and the number of substrates treated obtained from experience or based on the results of chemical analysis or the like on a liquid sample; however, with such a judgment method, it is difficult to carry out judgment quickly and accurately.

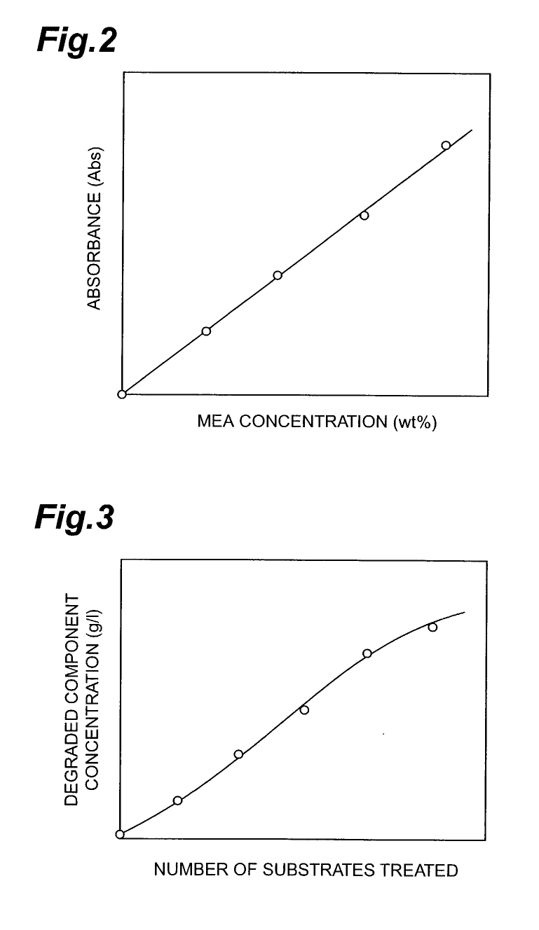

In contrast, the present inventors carried out studies focusing on the relationship between the MEA concentration of the non-water-based resist stripping liquid and the absorbance of the non-water-based resist stripping liquid, and as a result discovered that if probe light of measurement wavelength λ=1048 nm is used, then a high degree of correlation is shown between the MEA concentration and the absorbance as shown in FIG. 2, with there being no effects from degraded components and the like, and hence that the MEA concentration can be determined accurately by measuring the absorbance.

The absorptiometer 15 installed online in the pipeline 10 has various compensatory functions for minimizing the measurement error, and the absorbance measurement value of the sample liquid led into the absorptiometer 15 from the pipeline 10 is inputted into the absorbance controller 30. The absorbance controller 30 outputs control signals to the flow rate control valves 24 to 27 based on the difference between the measurement value and a preset target value. As a result, automatic control of each of the flow rate control valves 24 to 27 is carried out, and replenishing liquid is fed into the resist stripping treatment bath 1 as appropriate such that the absorbance of the non-water-based resist stripping liquid in the resist stripping treatment bath 1 becomes this target value, i.e. such that the MEA concentration becomes a target value.

Moreover, degradation of the resist stripping performance is contributed to not lonely by the MEA concentration as described above but also be the degraded component concentration. Non-water-based resist stripping liquid is taken out of the resist stripping treatment bath 1 by the liquid feeding pump 8 and used in a circulatory fashion via the resist stripping liquid sprayer 7, and hence the concentration of dissolved substances in the non-water-based resist stripping liquid gradually increases. The main such dissolved substances include the resist and N,N-bis (2-hydroxyethyl)oxamide, and as shown in the operation example of FIG. 3, the degraded component concentration increases as the number of substrates 6 treated increases. This will result in a marked drop in the resist stripping performance.

Conventionally, such changes in the degraded component concentration have not been measured constantly in real time, and management of the degraded component concentration has not been carried out such that the resist stripping performance is constant. Specifically, conventionally, the number of substrates 6 treated has been taken as a degradation indicator, but because the substrate shape, the resist film thickness, the resist stripping pattern and the like are not constant, the amount of dissolved resist also differs according to the type of the substrates 6, and hence it is not appropriate to use the number of substrates treated in the judgment of degradation of the resist stripping performance in this way.

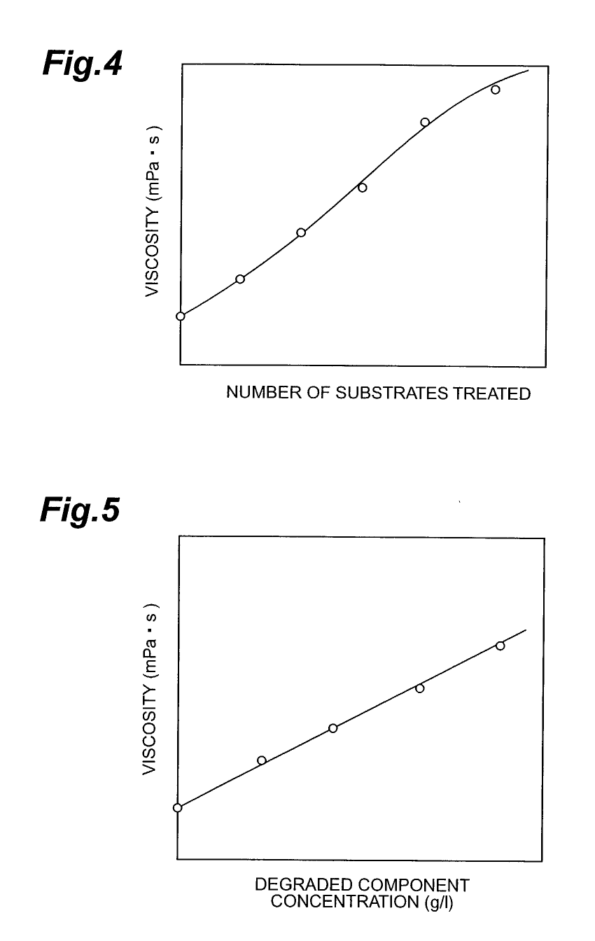

In contrast, the present inventors carried out studies into the state of contamination due to increase in the resist concentration in the non-water-based resist stripping liquid, and focusing on the relationship between the degraded component concentration in the non-water-based resist stripping liquid and the viscosity of the non-water-based resist stripping liquid, obtained as one example the results shown in FIG. 4 and FIG. 5.

As shown in FIG. 5, a high degree of correlation is shown between the degraded component concentration in the non-water-based resist stripping liquid and the viscosity of the non-water-based resist stripping liquid, with there being no effects from the MEA concentration and the like, and hence it is possible to carry out limit value judgment for the resist stripping performance from the degraded component concentration itself by measuring and controlling the viscosity, with no regard given to the number of substrates treated.

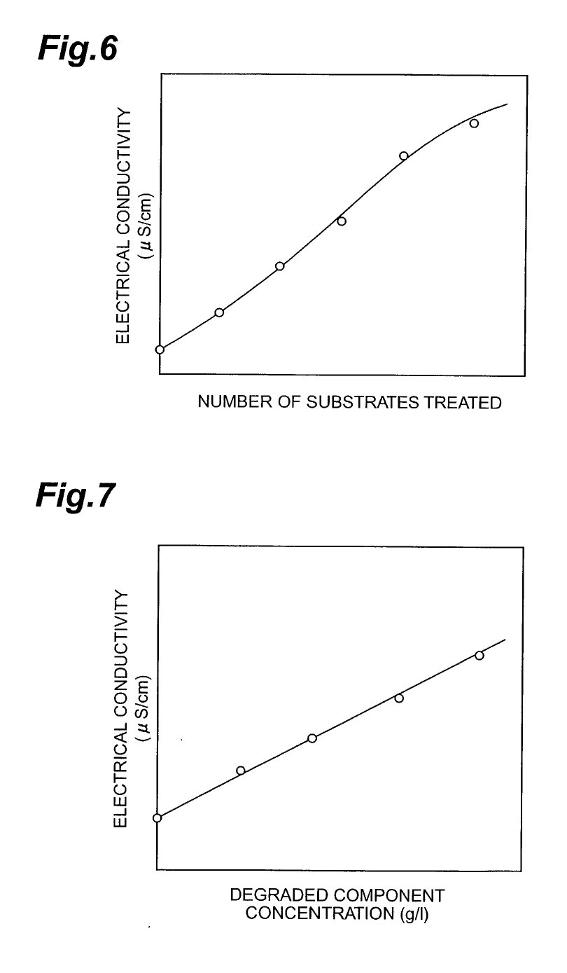

Furthermore, from the studies into the state of contamination due to increase in the resist concentration in the non-water-based resist stripping liquid, focusing on the relationship between the degraded component concentration in the non-water-based resist stripping liquid and the electrical conductivity of the non-water-based resist stripping liquid, the present inventors obtained as one example the results shown in FIG. 6 and FIG. 7.

As shown in FIG. 7, a high degree of correlation is shown between the degraded component concentration in the non-water-based resist stripping liquid and the electrical conductivity of the non-water-based resist stripping liquid, with there being no effects from the MEA concentration and the like, and hence it is possible to carry out limit value judgment for the resist stripping performance from the degraded component concentration itself by measuring and controlling the electrical conductivity, with no regard given to the number of substrates treated.

Consequently, by continuously measuring the viscosity or the electrical conductivity using the analyzer 16, which is installed integrated with or separate to the absorptiometer 15 in the pipeline 10, the degraded component concentration in the non-water-based resist stripping liquid is obtained, and when it is detected that the degradation limit value has been exceeded, fresh resist stripping liquid is replenished into the resist stripping treatment bath 1 based on output signals from the analyzer controller 31. As a result, the degraded component concentration in the non-water-based resist stripping liquid is reduced to the degradation limit value or below, and hence the resist stripping performance is restored. Note that it is preferable for the measurement of the degraded component concentration to be carried out with the temperature of the non-water-based resist stripping liquid held constant.

A more detailed description will now be given of the functioning of the control system of the present apparatus. Firstly, when the bath is first made up and the resist stripping treatment bath 1 is empty, the liquid surface level gauge 3 detects that the resist stripping treatment bath 1 is empty, the opening amounts of the flow rate control valves 24 to 27 are adjusted through output signals from the liquid surface level controller 29, and the various replenishing liquids are fed in at appropriate flow amount proportions. Next, the absorptiometer 15 continuously measures the absorbance of the non-water-based resist stripping liquid during the making up of the bath, the opening amount of at least one of the flow rate control valves 24 to 27 is adjusted throughout put signals from the absorbance controller 30, and the various replenishing liquids are fed in at appropriate small flow amounts. In this way, automatic control is carried out such that the MEA concentration in the non-water-based resist stripping liquid in the resist stripping treatment bath 1 becomes the target value.

When the resist stripping treatment of the substrates 6 is begun, the MEA concentration in the non-water-based resist stripping liquid proceeds to drop, the amount of liquid in the resist stripping treatment bath 1 proceeds to drop due to the liquid sticking to the substrates 6 and being taken out of the system, and the concentration of degraded components including dissolved resist proceeds to rise.

When the MEA concentration has dropped, because the absorptiometer 15 is continuously measuring the absorbance of the non-water-based resist stripping liquid, the opening amount of the flow rate control valve 25 is adjusted through an output signal from the absorbance controller 30, and the MEA stock liquid is fed in at an appropriate small flow amount, i.e. automatic control is carried out such that the MEA concentration becomes the target value.

On the other hand, in the case that the amount of liquid in the resist stripping treatment bath 1 has dropped due to the liquid sticking to the substrates 6 and being taken out of the system, the liquid surface level gauge 3 detects the reduced liquid surface level, the opening amount of at least one of the flow rate control valves 24 to 27 is adjusted through output signals from the liquid surface level controller 29, and the various replenishing liquids are fed in at appropriate flow amount proportions.

Furthermore, in the case that the degraded component concentration has increased and reached the degradation limit value, the analyzer 16, which continuously measures the degraded component concentration in the non-water-based resist stripping liquid, detects that the degradation limit value has been exceeded, the opening amount of at least one of the flow rate control valves 24 to 27 is adjusted through output signals from the analyzer controller 31, and the various replenishing liquids are fed in at appropriate flow amount proportions. In this way, fresh resist stripping liquid is replenished into the resist stripping treatment bath 1, and hence the degraded component concentration is reduced down to the degradation limit value, and thus the resist stripping performance of the non-water-based resist stripping liquid is restored.

Note that an overflow barrier is provided above the liquid surface level gauge 3 in the resist stripping treatment bath 1 in a position such that overflowing will not occur during normal operation, but it is not a problem if there is slight overflowing over the top of the overflow barrier.

The present inventors found that by carrying out operation control as described above, restoration of the resist stripping performance of the non-water-based resist stripping liquid, stable continuous operation, and reduction of the amount used of the non-water-based resist stripping liquid can all be realized.

To aid conceptual understanding, a description will now be given of the operation pattern and the effects exhibited for the apparatus and method of the present invention compared with a conventional method, with reference to FIGS. 8 to 11.

Firstly, as shown in FIG. 8, with the conventional method, the MEA concentration in the non-water-based resist stripping liquid is for example 40.0 wt % when operation is begun, and drops as time passes. The resist stripping liquid is completely replaced once the MEA concentration has reached for example 30.0 wt % (as measured by chemical analysis) . In this case, the graph showing the change in the MEA concentration with time is sawtooth-shaped (see FIG. 8). There are thus large changes in the MEA concentration, and hence the resist stripping performance is not constant.

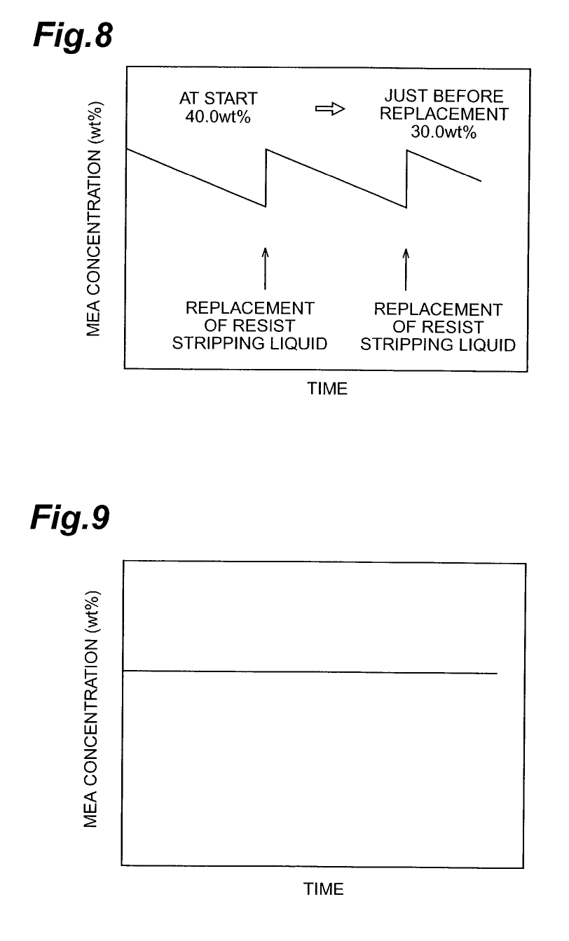

In contrast, as shown in FIG. 9, according to the apparatus and method of the present invention, the MEA concentration is kept approximately constant over time at for example 39.0±1.0 wt %. The resist stripping performance is thus made to be stable, and moreover the work of replacing the resist stripping liquid becomes unnecessary.

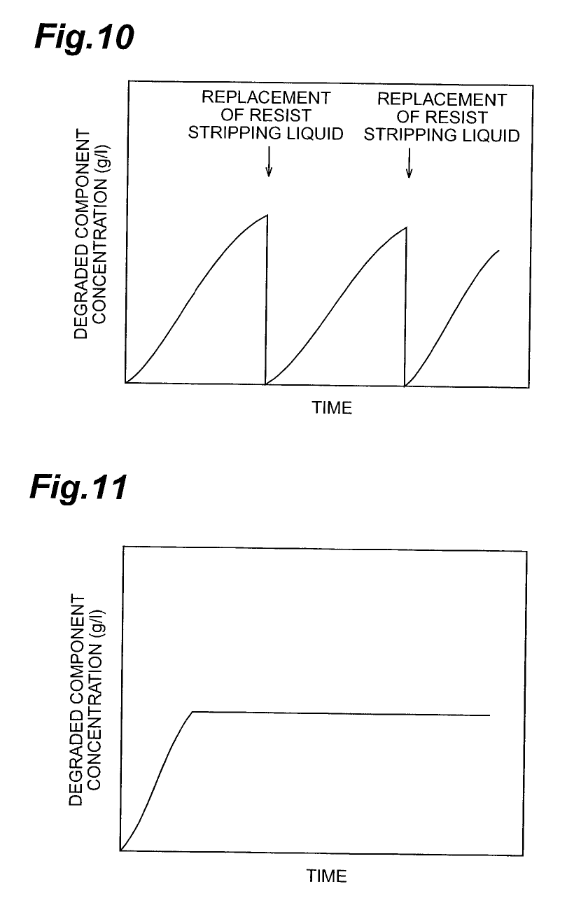

Moreover, as shown in FIG. 10, with the conventional method, the degraded component concentration in the non-water-based resist stripping liquid increases with time after operation has begun, and replacement of the resist stripping liquid is carried out once this concentration has reached the limit value (range) at which the resist stripping performance has dropped to an unacceptable level. In this case, the graph showing the change in the degraded component concentration with time is sawtooth-shaped (see FIG. 10) . There are thus large changes in the degraded component concentration, and hence the resist stripping performance is not constant.

In contrast, as shown in FIG. 11, according to the apparatus and method of the present invention, the degraded component concentration becomes approximately constant after a certain initial time period has passed. The resist stripping performance is thus made to be stable, and moreover the work of replacing the resist stripping liquid becomes unnecessary.

Note that the present invention is not limited to the embodiment described above, but rather various modifications are possible provided that the purport of the present invention is not deviated from. For example, instead of using a mixed solution of BDG and MEA as the non-water-based resist stripping liquid, it is possible to use a mixed solution of another organic solvent and MEA. Moreover, the present invention cannot only be applied to a single piece of resist stripping equipment, but it is also possible to adopt a form in which a non-water-based resist stripping liquid used with a plurality of pieces of resist stripping equipment is brought into and managed in a common adjusting bath (resist stripping treatment bath 1). Furthermore, it is also possible to provide a plurality of adjusting baths (resist stripping treatment baths 1 etc.), and carry out management of the resist stripping liquid in each of the baths.

Furthermore, instead of a viscosimeter or an electrical conductivity meter as the analyzer 16 used for measuring the degraded component concentration, it is also possible to use one or more of a pH meter, an ultrasonic concentration meter, a liquid densitometer, a refractometer, an automatic titration apparatus and so on. Moreover, the measurement of the amount of liquid in the resist stripping treatment bath 1 can also be carried out by measuring the volume or weight of the liquid.

As described above, according to the non-water-based resist stripping liquid management apparatus and method of the present invention, the MEA concentration and the degraded component concentration in a non-water-based resist stripping liquid can be constantly monitored and controlled so as to be desired target values, and moreover continuous operation over a prolonged time with a stable liquid surface level becomes possible. Moreover, the quality of the resist stripping liquid can be controlled so as to be constant, and hence the resist stripping performance can be made stable. As a result, it becomes possible to greatly reduce the amount of resist stripping liquid used, to increase the yield, to reduce the time for which operation is shut down, and to reduce labor costs.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A non-water-based resist stripping liquid management apparatus, which manages in an adjusting bath a non-water-based resist stripping liquid that is used in resist stripping equipment, the apparatus comprising:
degraded component concentration measurement means for measuring the concentration of a degraded component originating from the non-water-based resist stripping liquid in said adjusting bath;
liquid feeding means for feeding into said adjusting bath at least one of a non-water-based resist stripping stock liquid, a non-water-based resist stripping reclaimed liquid, and a premixed non-water-based resist stripping new liquid; and
liquid feeding amount control means for controlling the amount of liquid fed into said adjusting bath in accordance with the measured degraded component concentration.

2. The non-water-based resist stripping liquid management apparatus according to claim 1, wherein said degraded component concentration measurement means measures the concentration of a chemical species or chemical component that has arisen or can arise potentially through reaction of a constituent component of the non-water-based resist stripping liquid in said adjusting bath and/or a decomposition product of such a constituent component with oxygen and/or carbon dioxide in a gas containing oxygen and/or carbon dioxide.

3. The non-water-based resist stripping liquid management apparatus according to claim 1, wherein said degraded component concentration measurement means comprises at least one of a viscosimeter that measures the viscosity of the non-water-based resist stripping liquid in said adjusting bath and an electrical conductivity meter that measures the electrical conductivity of the non-water-based resist stripping liquid in said adjusting bath.

4. A non-water-based resist stripping liquid management method of managing in an adjusting bath a non-water-based resist stripping liquid that is used in resist stripping equipment, the method comprising:
a degraded component concentration measurement step of measuring the concentration of a degraded component originating from the non-water-based resist stripping liquid in said adjusting bath;
a liquid feeding step of feeding into said adjusting bath at least one of a non-water-based resist stripping stock liquid, a non-water-based resist stripping reclaimed liquid, and a premixed non-water-based resist stripping new liquid; and
a liquid feeding amount control step of controlling the amount of liquid fed into said adjusting bath in accordance with the measured degraded component concentration.

5. The non-water-based resist stripping liquid management method according to claim 4, wherein in said degraded component concentration measurement step, the concentration is measured of a chemical species or chemical component that has arisen or can arise potentially through reaction of a constituent component of the non-water-based resist stripping liquid in said adjusting bath and/or a decomposition product of such a constituent component with oxygen and/or carbon dioxide in a gas containing oxygen and/or carbon dioxide.

6. The non-water-based resist stripping liquid management method according to claim 4, wherein in said degraded component concentration measurement step, at least one of the viscosity and the electrical conductivity of the non-water-based resist stripping liquid in said adjusting bath is measured.
